(19) United States
(12) Patent Application Publication
(10) Pub. No.: US 2009/0182802 A1
(43) Pub. Date: Jul. 16, 2009

(54) MOBILE DEVICE MANAGEMENT SCHEDULING

(75) Inventors: Anh Tran, Seattle, WA (US); Hung Dang, Seattle, WA (US); Yuhang Zhu, Bellevue, WA (US); Chris Guillory, Kirkland, WA (US); Carl Wolz, Redmond, WA (US); Nikhil Deore, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/971,909

(22) Filed: Jan. 10, 2008

(51) Int. Cl. G06F 15/16; G06F 15/177

(52) U.S. Cl. 709/203; 709/221

(57) ABSTRACT

A mobile device management system is provided. The mobile device management system may include a device management client configured to be executed on a mobile computing device. The device management client may include a client scheduler module configured to contact a device management server via a computer network and download a device management schedule for storage on the mobile computing device. The device management schedule may be generated at the device management server and include one or more schedule items. Each schedule item may include a predefined event and an associated action. The client scheduler module may be configured to monitor the device management schedule, detect the predefined event defined in a schedule item, and perform the associated action associated with the event, to thereby configure software on the mobile computing device.

### BACKGROUND

Mobile computing devices, such as mobile phones and personal digital assistants (PDA), have become increasingly popular in recent years. The software executed on these mobile computing devices is often configured remotely by central device management servers. One difficulty faced by current device management technology is that unexpected events, such as interruptions in network connectivity between the mobile computing device and the server, can frustrate the remote management functions of the server. For example, the server may become unable to determine whether a configuration action on a mobile computing device was completed or not. This may lead to improperly configured software, potentially causing failure or suboptimum performance of the software on the mobile computing device.

### SUMMARY

A mobile device management system is provided. The mobile device management system may include a device management client configured to be executed on a mobile computing device. The device management client may include a client scheduler module configured to contact a device management server via a computer network and download a device management schedule for storage on the mobile computing device. The device management schedule may be generated at the device management server and include one or more schedule items. Each schedule item may include a predefined event and an associated action. The client scheduler module may be configured to monitor the device management schedule, detect the predefined event defined in a schedule item, and perform the associated action that is associated with the event, to thereby configure software on the mobile computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an embodiment of a mobile device management system, including a mobile computing device that includes a device management schedule generated at and downloaded from a device management server.

FIG. 2 is a diagram illustrating example communications between the mobile computing device and the device management server of the mobile device management system of FIG. 1.

FIG. 3 is a diagram of a data structure for a device management schedule utilized by the mobile device management system of FIG. 1.

FIG. 4 is a flowchart of an embodiment of a method for remotely managing a mobile computing device.

### DETAILED DESCRIPTION

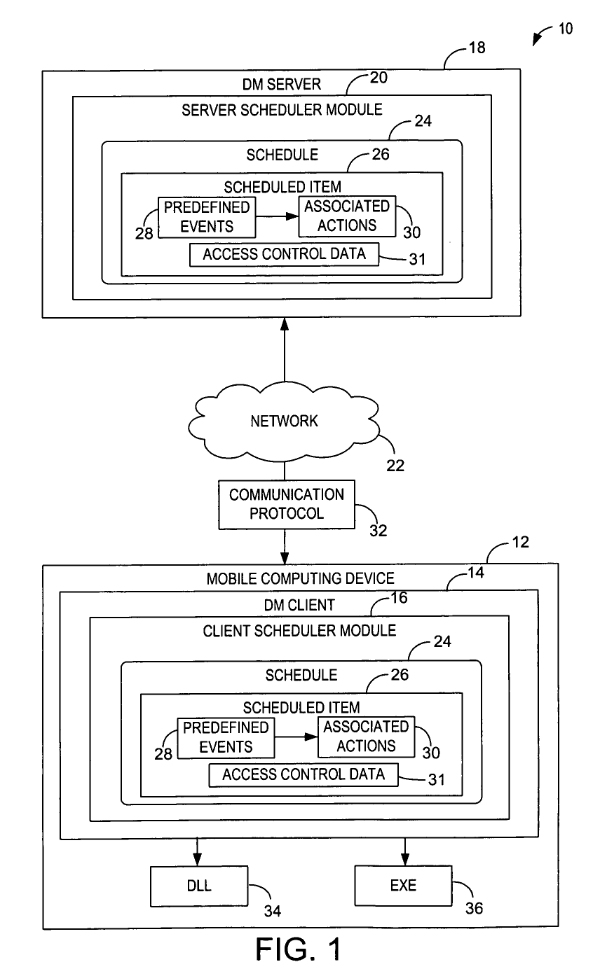

FIG. 1 is a schematic diagram of a mobile device management system 10 for remotely managing a mobile computing device 12 from a device management server 18. The mobile device management system 10 may include a device management client 14 configured to be executed on the mobile computing device 12, which in turn may include a client scheduler module 16. The device management client 14 may be configured to contact the device management server 18 via a computer network 22 and download a device management schedule 24 for storage on the mobile computing device 12, for example in a data store associated with the client scheduler module 16 of the mobile computing device 12. It will be appreciated that the computer network 22 may be a wireless computer network, and communication between the mobile computing device 12 and the device management server 18 may be carried out according to a communication protocol 32, such as a wireless access protocol (WAP). In one embodiment, the device management server 18 may be an open mobile alliance (OMA) device management server.

Prior to downloading, the device management schedule 24 may be generated at a server scheduler module 20 and/or stored on the device management server 18. In this way, policies may be centrally decided and implemented by promulgating suitable device management schedules 24 to one or more mobile computing devices 12 from the device management server 18.

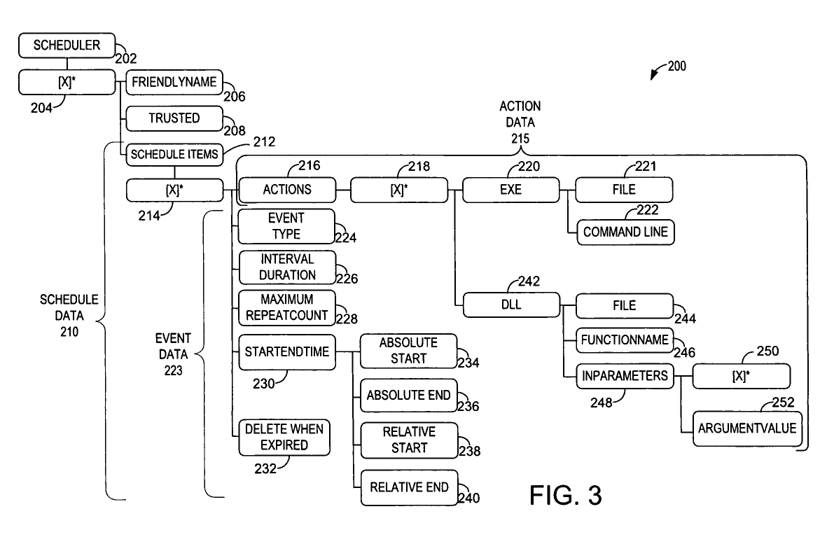

The device management schedule 24 may include one or more schedule items 26, each schedule item 26 including one or more predefined events 28 and one or more associated actions 30, such as an associated software configuration action. The device management schedule 24 may further include access control data 31 for controlling access to the device management schedule 24 by users of the mobile computing device 12. The device management schedule 24 may be represented in structured data stored in data structure, such as an XML data structure, as illustrated in FIG. 3.

The client scheduler module 16 may be configured to monitor the device management schedule 24, detect a predefined event 28 defined in a schedule item 26 of the device management schedule 24, and perform an associated action 30 associated with the event 28, to thereby configure software on the mobile computing device 12. It will be appreciated the client scheduler module 16 may further be configured to determine that an event 28 in a schedule item 24 would have occurred during a period of inactivity of the mobile computing device, such as when the device is powered off, and perform an action associated with the event upon resumption of activity of the mobile computing device, such as when the device is powered on.

Various events 28 and associated actions 30 may be defined to achieve device management functionality for the mobile computing device 12. For example, the predefined event 28 may be a time event, such as occurrence of a relative time interval (e.g., 5 minutes after boot up) or an absolute time (e.g., 12:00:00am). The predefined event 28 may also be a state event, such as boot up, detecting a predetermined connection type such as a Wi-Fi connection or a cellular connection, and/or reestablishing network connection after initially losing network connectivity, or other state of the mobile computing device 12. It will be appreciated that losing network connectivity may have various causes, such as powering off of the mobile computing device 12 and/or the mobile computing device 12 falling into a wireless service hole.

The associated action 30 may include a software configuration action, such as software installation, configuration, and/or update. It will also be appreciated that the associated action 30 may include accessing an executable file 36 or a dynamic link library (DLL) 34 on the mobile computing device 12, and/or initiating contact with the device management server 18. The client scheduler module 16 may provide two host processes to load DLL, a trusted process and an untrusted process. It will be appreciated that loading DLLs is an action that may make the scheduling component flexible to use with certain operating systems wherein there are process limits. It will also be appreciated that a variety of other actions 30 may be defined to achieve a desired software configuration functionality.

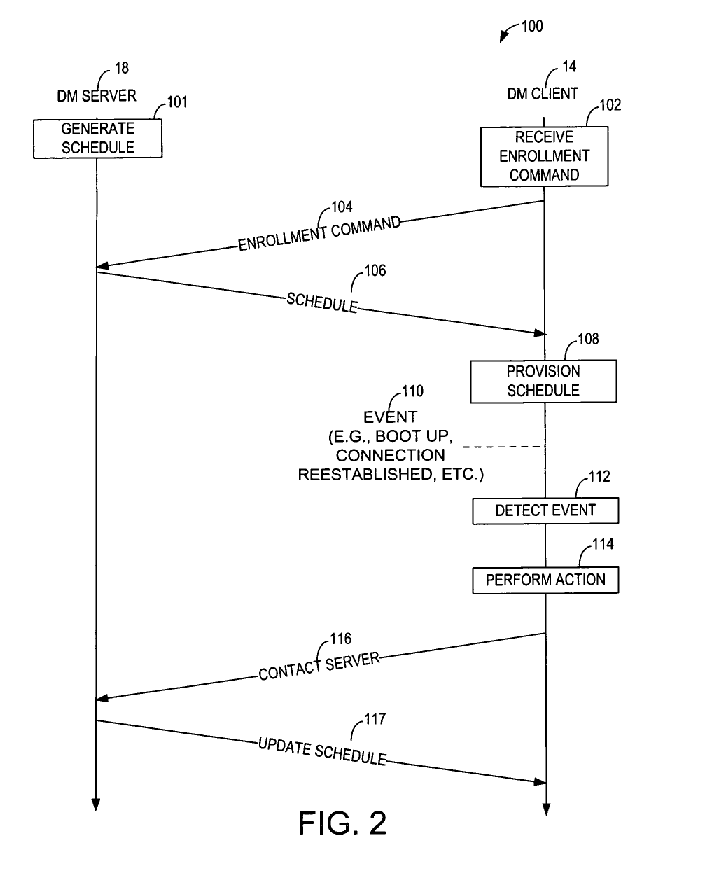

FIG. 2 is a diagram illustrating example communications between the device management client 14 and the device management server 18. At 101, a device management schedule may be generated at the device management server 18, for example according to a server-side policy for managing mobile device 12. At 102, the device management client 14 may receive an enrollment command to enroll in remote device management from a user, for example via a graphical user interface presented on the mobile computing device 12. At 104, upon receiving the enrollment command, the device management client 14 may transmit the enrollment command to the device management server 18, to thereby enroll the mobile device 12 in remote device management scheduling. Thus, it will be appreciated that the device management 10 system operates in a “pull” mode rather than “push” mode, since the device management client 14 initiates contact with the device management server 18.

At 106, the device management client 14 on the mobile computing device 12 may download a device management schedule 24 from the device management server 18. At 108, the device management schedule 24 may be provisioned, or installed, on the mobile computing device 12 by the device management client 14. The device management client 14 monitors whether an event of the device management schedule 24 is detected.

At 110, a predefined event 28 may occur, such as a time event, or a state event such as boot up, reestablishment of connectivity, etc. At 112, the device management client 14 may detect the occurrence of the predefined event 28. In response, at 114, the device management client 14 may perform a software configuration action 30 associated with the event 28, to thereby configure software on the mobile computing device 12.

At 116, the device management client 14 may contact the device management server 18, for example, to send a confirmation reporting successful detection of the event 28 and completion of the action 30. Thus, the device management server 18 may be configured to receive the confirmation message from the client schedule module 16 indicating whether the event 28 was detected and whether the action 30 was performed in response to the event 28 being detected.

At 117, the device management server 18 may be further configured to download an updated device management schedule 24 including one or more updated schedule items 26 to the client scheduler module 16 executed on the mobile computing device 12. The updated device schedule may be generated by the device management server 18 based on server side policies, and also based on information received from the client scheduler module 16, at 116.

It will be appreciated that one example scenario in which the above described system may be utilized is updating of software on the mobile computing device, where the updating requires power down and boot up of the device. In such a scenario, a device management schedule may be defined with a schedule item including an event of boot up and an associated action of contact server to report completion of installation. In this manner the device management schedule may be used to report successful configuration of the software, even after power down and boot up of the mobile computing device 12.

As shown in FIG. 3, the device management schedule 24 may be stored in a data structure 200, which may be encoded in an extensible markup language (XML) format. Data structure 200 may include a root node 202 for a scheduler object, which may be read by client scheduler module 16. The root node 202 includes a placeholder node 204 for one or more applications identified by a global user identification (GUID). It will be appreciated that such a configuration enables the logical grouping of device management schedules 24 into application-specific collections. For example, a grouping of device management schedules 24 utilized in updating of software on the mobile computing device may be created.

A friendly name node 206 may optionally be provided to identify a human readable name for the application. A trusted node 208 stores data indicating a level of trust for the device management schedule 24. In trusted node 208, a value of true may indicate that the schedule data for the application is stored in a secure database and may only be accessed by trusted code. A value of false may indicate that the schedule data for the application is stored in a non-secure database and may be accessed by trusted or untrusted code. For improved security, the default may be set to false. It will be appreciated that the device management server 18 may instruct, via a schedule, the device management client 14 to connect to the device management server 18 so that the device management server 18 can access and apply various policies, such as a group policy, security policy, etc. Users who wish to alter the schedule and avoid the application of such policies may face a high security bar, since the schedule may be protected and code that attempts to access the schedule may be presumed to be untrusted.

Data structure 200 may further include schedule data 210, which in turn includes a schedule list node 212 that contains a list of schedule items 26, and a schedule placeholder node 214, which functions as a placeholder for one or more schedule items 26. Each sibling node of the placeholder node 214 holds info comprising an application-specific schedule item 26.

Data structure 200 may further include event data 223, which contains data related to predefined events 28 for a schedule item 26. Event data 223 may include an event type node 224, which defines the type of event 28 that triggers the action 30 device management schedule 24. Example event types include time events, such as an interval event, and state events, such as boot up, reestablishment of connectivity, etc., as described above. Thus, in one embodiment, a value of “Interval” indicates the action 30 of the schedule item 26 is triggered at an absolute or relative start time indicated by the StartAndEndTimes node 230, and repeats according to value in the IntervalDuration node 236 (which may be expressed in minutes between schedule events, for example) and the value in the MaximumRepeatCount node 238. A value of “OnBootUp” indicates the action 30 of the schedule item 26 is triggered when boot up of the mobile computing device 12 occurs.

The IntervalDuration node 236 typically includes data representing the base number of minutes between schedule events. The MaximumRepeatCount node 238, if present, includes the number of times to repeat the schedule event, which generally does not exceed past the end date and time defined for the schedule. If not present, the schedule item 26 may be configured to repeat indefinitely, not to exceed past the end date and time defined for the schedule item 26.

The StartAndEndTimes node 240 contains data about when the event 28 in the schedule item 26 starts and ends. This data may be expressed as an absolute or relative start and end time, and may be respectively stored in absolute start node 234, absolute end node 236, relative start end node 238, and relative end node 240. Absolute start and end times may be expressed in coordinated universal time (UTC), while the relative start and end times may contain the number of minutes relative to the time of provisioning of the device management schedule that the device management schedule 24 is to begin and end, respectively. Upon provisioning, the client scheduler module 16 may dynamically create or overwrite the AbsoluteStart ad AbsoluteEnd time if they exist, setting them to the current time plus the RelativeStart and RelativeEnd values, respectively. If RelativeStart is used, AbsoluteStart is typically omitted, and if RelativeEnd is used, AbsoluteEnd is typically omitted. [00261 The event data 223 may further include a DeleteWhenExpired node 232. If set to true, the schedule item 26 is deleted after it expires, e.g., if the current time is greater than the AbsoluteEnd time. If set to false, this schedule item 26 is not deleted after it expires. The default value may be set to false.

Data structure 200 may further include action data 215 that defines actions 30 that are associated with events 28. Action data 215 may include an action node 216 that includes a list of actions. Calling an execution function on this node will execute the actions of the schedule item 26 upon being called. Action data 215 may further include a placeholder node 218, each sibling node of which is configured to hold data defining an action 30.

Action data 215 may further include an executable node 220 containing information used to call an executable file on the mobile computing device 12, such as an executable file path stored in file node 221 and command line parameters stored in command line node 222.

Action data 215 may further include a DLL node 242 containing information for calling a DLL, such as a file path to a DLL file stored in DLL file node 244, a DLL function name stored in DLL function name node 246, and parameters (e.g., in a left to right ordered list) passed to the DLL function stored in DLL InParameter node 248. InParameter node 248 may further include children nodes, including a placeholder node 250 that holds one or more arguments. Each sibling node of the placeholder node 250 has an identifying name, and holds the type and value of an argument. Argument value node 252 holds a value to pass to the DLL function for the associated argument.

It will be appreciated that the device management schedule 24 may be encoded using a data structure 200 as described above, and communicated from the server schedule module 20 on the device management server 18 to the device management client 14 on the mobile computing device 12.

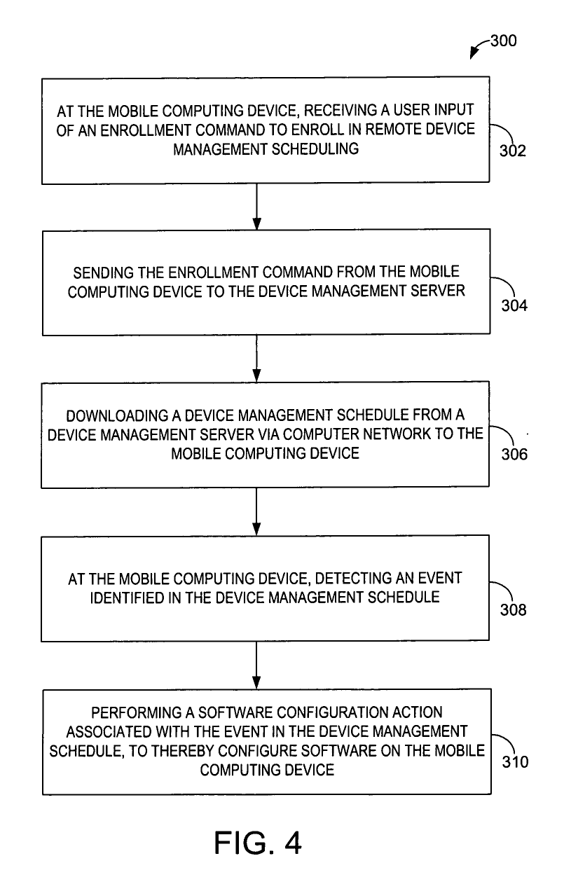

FIG. 4 is a flowchart of an embodiment of a method 300 for remotely managing a mobile computing device, which may be implemented using the computing devices described above, or other suitable devices. At 302, the method may include receiving at a mobile computing device a user input of an enrollment command to enroll in remote device management scheduling. At 304, the method may further include sending the enrollment command from the mobile computing device to a device management server, via a computer network, such as a wireless computer network, using a communications protocol, such as a wireless access protocol.

At 306, the method may include, at the mobile computing device, downloading a device management schedule from the device management server via the computer network. As discussed above, the device management schedule may be generated at and/or stored on the device management server prior to downloading, and may include one or more schedule items, each schedule item including a predefined event and an associated action. The predefined event may be a time event, such as a predefined time interval or an absolute time, or a state event, such as boot up or reestablishing a network connection after losing the network connectivity, as described above. The device management schedule may be represented in as structured data stored in a data structure, such as an XML data structure.

In some instances, multiple events may be utilized in a schedule item. For example, the event detected may be a first event, and the method may include grouping a second event with the first event and detecting the occurrence of the first and the second event. In this manner a plurality of events may be defined to trigger an associated action. The associated action may include a software configuration action, such as a software installation, configuration, and/or update.

At 308, the method may include, at the mobile computing device, detecting the occurrence of an event identified predefined in the device management schedule. At 310, the method may further include in response to detecting the occurrence of the event, performing an associated action, such as a software configuration action, associated with the event in the device management schedule, to thereby configure software on the mobile computing device.

Performing the software configuration action may include updating a setting or software on the mobile computing device, for example by executing an executable file on the mobile computing device or accessing a dynamic link library on the mobile computing device. Performing the software configuration action may further include sending a confirmation message that the setting or software has been updated to the device management server from the mobile computing device.

In some instances, multiple software configuration actions may be utilized in a schedule item. For example, the software configuration action performed may be a first software configuration action, and the method may further include grouping a second software configuration action with the first software configuration action and performing both the first software configuration action and the second software configuration action upon detecting the occurrence of the event identified in the device management schedule.

In one scenario, detecting the event at 310 may include for example first detecting a loss of network connectivity during performing a software configuration action through a boot-up or network communications interruption, and second detecting a reestablishment of network connectivity, and performing the software configuration at 312 may include initiating a contact with device management server from the mobile computing device, according to the device management schedule.

In another scenario, performing the software configuration action may include initiating contact with the device management server from the mobile computing device according to the device management schedule stored on the mobile computing device. For example, the software configuration action may be to contact the server following installation of software and boot up of the mobile computing device, to report that the software installation was successfully completed.

In some embodiments, the method may additionally include at the mobile computing device setting access control parameters for the device management schedule on the mobile computing device, defining users and/or groups that may view and modify the device management schedule. By setting the access control parameter appropriately, an administrator may regulate the users and groups that can access the schedules.

The above described systems and methods may be utilized to efficiently provision device management schedules on mobile computing devices from a device management server, and configure software on the mobile computing devices according to the device management schedules.

It will be appreciated that the computing devices described herein typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A mobile device management system, comprising:
a device management client configured to be executed on a mobile computing device, the device management client including a client scheduler module configured to contact a device management server via a computer network and download a device management schedule for storage on the mobile computing device, the device management schedule being generated at the device management server and including one or more schedule items, each schedule item including a predefined event and an associated action;
wherein the client scheduler module is configured to monitor the schedule, detect an event defined in a schedule item, and perform a software configuration action associated with the event, to thereby configure software on the mobile computing device.

2. The mobile device management system of claim 1, wherein the event is a time event or a state event.

3. The mobile device management system of claim 2, wherein the state event is boot up.

4. The mobile device management system of claim 1, wherein the software configuration action includes accessing an executable file or a dynamic link library on the mobile computing device.

5. The mobile device management system of claim 1, wherein the schedule is represented in structured data stored in an XML file.

6. The mobile device management system of claim 1, wherein the schedule further includes access control data for controlling access to the schedule by users of the mobile computing device.

7. The mobile device management system of claim 1, wherein the event includes reestablishing network connection after losing network connectivity, and the software configuration action includes initiating contact with the device management server.

8. The mobile device management system of claim 1, wherein the client scheduler module is configured to determine that an event in a schedule item would have occurred during a period of inactivity of the mobile computing device, and perform an action associated with the event upon resumption of activity of the mobile computing device.

9. A mobile device management system, comprising:
a device management server configured to generate a device management schedule, the device management schedule including one or more schedule items, each schedule item including a predefined event and an associated action, the server further being configured to download the device management schedule to a client scheduler module executed on a mobile computing device;
wherein the device management server is further configured to receive a confirmation message from the client schedule module indicating whether the event was detected and whether the action was performed in response to the event being detected; and
wherein the device management server is further configured to download an updated schedule including one or more updated schedule items to the client scheduler module.

10. A method of managing a mobile computing device from a device management server, comprising:
at the mobile computing device, downloading a device management schedule from a device management server via a computer network;
detecting an event identified in the device management schedule; and
performing a software configuration action associated with the event in the device management schedule, to thereby configure software on the mobile computing device.

11. The method of claim 10, wherein the device management schedule is generated at the device management server.

12. The method of claim 10, wherein the event is a time event or a state event.

13. The method of claim 12, wherein performing the software configuration action includes updating a setting or software on the mobile computing device.

14. The method of claim 13, wherein performing the software configuration action further includes sending a confirmation message that the setting or software has been updated to the device management server from the mobile computing device.

15. The method of claim 14, wherein performing the software configuration action includes executing an executable file or accessing a dynamic link library on the mobile computing device.

16. The method of claim 13,
wherein detecting the event includes first detecting a loss of network connectivity during performing the software configuration action through a boot-up or a network communications interruption, and second detecting a reestablishment of network connectivity; and
wherein performing the software configuration action includes initiating contact with device management server from the mobile computing device, according to the schedule.

17. The method of claim 10, further comprising, prior to downloading the device management schedule, receiving a user input of an enrollment command to enroll in remote device management scheduling at the mobile computing device, and sending the enrollment command from the mobile computing device to the device management server to enroll the mobile computing device in remote device management scheduling.

18. The method of claim 10, wherein the event is a first event, further comprising grouping a second event with the first event and detecting the occurrence of both the first and the second event.

19. The method of claim 10, wherein the software configuration action is a first software configuration action, further comprising grouping a second software configuration action with the first software configuration action and performing both the first software configuration action and the second software configuration action upon detecting the occurrence of the event.

20. The method of claim 10, further comprising:
setting access control parameters for the schedule on the mobile computing device, defining users and/or groups that may view and modify the schedule.
